(19) United States
(12) Patent Application Publication
(10) Pub. No.: US 2012/0274263 A1
(43) Pub. Date: Nov. 1, 2012

(54) POWER MANAGEMENT SYSTEM AND METHOD THEREOF

(75) Inventors: Kuo-Sen Kung, Kaohsiung City (TW); Chun-Hao Tu, Changhua County (TW); Ren-Hong Jhan, Yunlin County (TW); Yu-Jung Liu, Kaohsiung City (TW); Wei-Cheng Wu, Taichung City (TW); Jiun-Jye Chang, Hsinchu City (TW); Po-Lun Chen, Hsinchu County (TW); Wei-Jhih Lian, New Taipei City (TW); Liu-Yi Huang, New Taipei City (TW); Lin-Yuan You, Taipei City (TW); Ying-Hung Lin, New Taipei City (TW); Wei-Ming Lee, Taipei City (TW)

(73) Assignee: AU OPTRONICS CORPORATION, Hsinchu (TW)

(21) Appl. No.: 13/236,616

(22) Filed: Sep. 19, 2011

(30) Foreign Application Priority Data
Apr. 29, 2011 (TW) 100115161

(51) Int. Cl. H02J 7/00; G05F 3/02

(52) U.S. Cl. 320/101; 323/304

(57) ABSTRACT

A system for power management electrically connected to a solar cell is provided. The system for power management includes a photo-sensor, a controller electrically connected to the photo-sensor, and a power manager. The photo-sensor detects an illumination (illuminance or irradiance) of an environment where the solar cell is located. A look-up table of illumination vs. maximum output power is built in the controller, wherein a corresponding maximum output power is determined by the controller according to the illumination detected by the photo-sensor. The power manager is electrically connected to the controller and the solar cell. The power manager controls the output current of the solar cell so as to equalize an output power of solar cell and the corresponding maximum output power. A method for power management is also provided.

### CROSS-REFERENCE TO RELATED APPLICATION

This application claims the priority benefit of Taiwan application serial no. 100115161, filed on Apr. 29, 2011. The entirety of the above-mentioned patent application is hereby incorporated by reference herein and made a part of this specification.

### BACKGROUND OF THE INVENTION

1. Field of the Invention

The invention relates to a power management system and a power management method, and more particularly, to a power management system and a power management method for managing an output power of a solar cell.

2. Description of Related Art

Solar energy is a clean, non-polluting, inexhaustible energy source. With the current fossil energy pollution and shortage problems, solar power has been the focus of attention. Since solar cells can directly convert solar energy to electrical energy, solar cells have become a relatively important research topic in current industry.

Solar cells have gradually been applied in buildings and portable electronics (such as cell phones and notebook computers). Compared with solar cells designed in buildings, solar cells in portable electronics are more likely to experience a quick change of illumination of the environment it is in, and every time the illumination of an environment where the solar cell is located changes, a corresponding maximum output power of the solar cell will also change. Thus, how to estimate the corresponding maximum output power of the solar cell according to the environment where the solar cell is located and enable the solar cell to always output as the corresponding maximum output power is an important topic.

Currently, conventional technology uses dynamic tracking to estimate the maximum output power corresponding to the illumination of the environment. For example, the maximum output power corresponding to the illumination of the environment is estimated through progressively adjusting the output current and voltage of the solar cell to calculate the output power of the solar cell, and then tracking the maximum output power of the solar cell that is corresponding to the illumination of the environment). However, the dynamic tracking method usually requires a lot of time in order to track the correct maximum output power. In addition, when the illumination of the environment where the solar cell is located changes quickly or significantly, the dynamic tracking method cannot obtain the correct maximum output power, causing the solar cell unable to be outputted as the maximum output power.

In light of the above, how to quickly and correctly estimate the corresponding maximum output power of different illuminations is a problem one skilled in the art would like to solve.

### SUMMARY OF THE INVENTION

The invention provides a power management system and a power management method, to quickly and effectively control an output power of a solar cell.

The invention provides a power management system electrically connected with a solar cell. The power management system includes a photo-sensor, a controller, and a power manager. The photo-sensor detects an illumination of an environment where the solar cell is located. The illumination is, for example, illuminance (lux) and/or irradiance (W/m²). The controller is electrically connected to the photo-sensor. A look-up table of illumination vs. maximum output power is built in the controller, and a corresponding maximum output power (the maximum output power is, for example, shown in the form of a corresponding output voltage or output current) is determined by the controller according to the look-up table of illumination vs. maximum output power and the illumination detected by the photo-sensor. The power manager is electrically connected to the controller and the solar cell. The power manager controls an output current of the solar cell so as to equalize an output power of the solar cell and the corresponding maximum output power.

In an embodiment of the invention, the photo-sensor continuously detects the illumination of the environment where the solar cell is located, and the controller continuously updates the corresponding maximum output power according to the look-up table of illumination vs. maximum output power and the illumination detected by the photo-sensor.

In an embodiment of the invention, the look-up table of illumination vs. maximum output power includes a plurality of candidate information sets. Each of the candidate information sets includes a candidate illumination and a candidate maximum output power. A method of the controller determining the maximum output power includes: selecting a candidate illumination from the look-up table of illumination vs. maximum power output closest to the illumination detected by the photo-sensor, and setting the candidate output power corresponding to the candidate illumination as the corresponding maximum output power.

In an embodiment of the invention, the look-up table of illumination vs. maximum output power includes a plurality of candidate information sets. Each of the candidate information sets includes a candidate illumination and a candidate maximum output power. A method of the controller determining the maximum output power includes: selecting two candidate illuminations from the look-up table of illumination vs. maximum power output closest to the illumination detected by the photo-sensor, wherein the illumination detected by the photo-sensor is between the two selected candidate illuminations, and calculating the corresponding maximum output power through interpolation.

In an embodiment of the invention, the look-up table of illumination vs. maximum output power includes a plurality of candidate information sets. Each of candidate information sets includes a candidate illumination and a candidate maximum output power. A method of the controller determining the maximum output power includes: selecting two candidate illuminations from the look-up table of illumination vs. maximum power output closest to the illumination detected by the photo-sensor, wherein the illumination detected by the photo-sensor is not between the two selected candidate illuminations, and calculating the corresponding maximum output power through extrapolation.

In an embodiment of the invention, the power management system further includes a voltage regulator, electrically connected with the power manager and the controller. In addition, the power management system can selectively include a load electrically connected to the voltage regulator.

In an embodiment of the invention, the power management system further includes a load electrically connected with the power manager and the controller.

In an embodiment of the invention, the load includes a battery.

The invention further provides a power management method, for managing an output power of a solar cell. The power management method includes the following steps. An illumination of an environment where the solar cell is located is detected. A maximum output power of the solar cell is determined according to a look-up table of illumination vs. maximum output power and the detected illumination. An output current and/or an output voltage of the solar cell is controlled so as to equalize an output power of the solar cell and the corresponding maximum output power.

In an embodiment of the invention, the illumination of the environment the solar cell is located is continuously detected, and the maximum output power is continuously updated.

In an embodiment of the invention, the look-up table of illumination vs. maximum output power includes a plurality of candidate information sets. Each of the candidate information sets includes a candidate illumination and a candidate maximum output power (the candidate maximum output power is, for example, shown in the form of a corresponding output voltage or output current). A method of determining the maximum output power includes: selecting a candidate illumination from the look-up table of illumination vs. maximum power output closest to the illumination detected by the photo-sensor, and setting the candidate output power corresponding to the candidate illumination as the corresponding maximum output power.

In an embodiment of the invention, the look-up table of illumination vs. maximum output power includes a plurality of candidate information sets. Each of the candidate information sets includes a candidate illumination and a candidate maximum output power (the candidate maximum output power is, for example, shown in the form of a corresponding output voltage or output current). A method of determining the maximum output power includes: selecting two candidate illuminations from the look-up table of illumination vs. maximum power output closest to the illumination detected by the photo-sensor, wherein the illumination detected by the photo-sensor is between the two candidate illuminations, and calculating the maximum output power through interpolation.

In an embodiment of the invention, the look-up table of illumination vs. maximum output power includes a plurality of candidate information sets. Each of the candidate information sets includes a candidate illumination and a candidate maximum output power (the candidate maximum output power is, for example, shown in the form of a corresponding output voltage or output current). A method of determining the maximum output power includes: selecting two candidate illuminations from the look-up table of illumination vs. maximum power output closest to the illumination detected by the photo-sensor, wherein the illumination detected by the photo-sensor is not between the two candidate illuminations, and calculating the maximum output power through extrapolation.

Since the invention adopts a photo-sensor to detect the illumination (illuminance or irradiance) of an environment where the solar cell is located, and builds a look-up table of illumination vs. maximum output power in a controller, thus the power management system and the power management method of the invention can quickly and correctly obtain the maximum output power (shown in the form of a corresponding output voltage or output current) of the solar cell, causing the electrical power generated by the solar cell to be effectively used.

To make the above and other objectives, features, and advantages of the invention more comprehensible, several embodiments accompanied with figures are detailed as follows.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a power management system according to a first embodiment of the invention.

FIG. 2 is a schematic view of a flow diagram of a power management method according to an embodiment of the invention.

FIG. 3 is a schematic view of a power management system according to a second embodiment of the invention.

FIG. 4 is a schematic view of a power management system according to a third embodiment of the invention.

FIG. 5 is a schematic view of a power management system according to a fourth embodiment of the invention.

### DESCRIPTION OF EMBODIMENTS

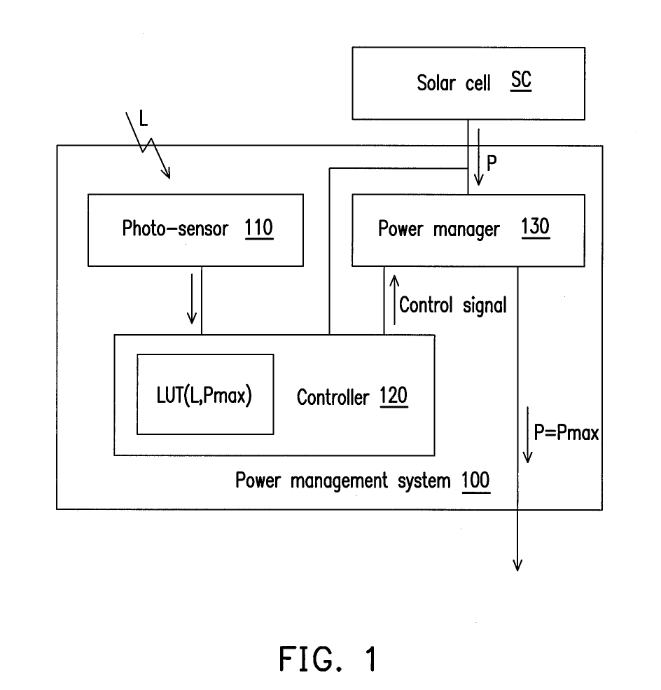

FIG. 1 is a schematic view of a power management system according to a first embodiment of the invention. Referring to FIG. 1, a power management system 100 is suitable to be electrically connected with a solar cell SC. The power management system 100 includes a photo-sensor 110, a controller 120, and a power manager 130. The photo-sensor 110 detects an illumination L of an environment where the solar cell SC is located, and the illumination L is, for example, illuminance (lux) or irradiance (W/m²). The controller 120 is electrically connected to the photo-sensor 110, wherein a look-up table LUT of illumination vs. maximum output power (L, Pmax) is built in the controller 120, and a corresponding maximum output power Pmax (the maximum output power Pmax is, for example, shown in the form of a corresponding output voltage or output current) is determined by the controller 120 according to the look-up table LUT of illumination vs. maximum output power (L, Pmax) and the illumination L detected by the photo-sensor 110. The power manager 130 is electrically connected to the controller 120 and the solar cell SC. The power manager 130 controls an output voltage and/or output current of the solar cell SC so as to equalize an output power P of the solar cell SC and the corresponding maximum output power Pmax.

In the embodiment, the solar cell SC is, for example, an organic solar cell or an inorganic solar cell. In detail, the solar cell SC is, for example, a single crystalline Si solar cell, a poly crystalline Si solar cell, an amorphous Si-based solar cell (Si, SiC, SiGe, SiH, SiO, etc), a single crystalline GaAs solar cell, a single crystalline InP solar cell, a poly crystalline CdS solar cell, a poly crystalline CdTe solar cell, or a poly crystalline CuInSe solar cell, etc. In addition, the photo-sensor 110 is, for example, a photo-diode, a photo transistor, a photo resistor, or any other component that can produce a photo current or sensing signal after receiving light. It should be noted that an absorption spectrum of the photo-sensor 110 is, for example, close to or partially overlapping with an absorption spectrum of the solar cell SC.

In light of the above, the controller 120 of the embodiment is, for example, a micro control unit (MCU), and the controller 120 is suitable to receive a signal (for example a voltage signal or a current signal) outputted by the photo-sensor 110 to determine the illumination L (illuminance and/or irradiance) detected by the photo-sensor 110. In the embodiment, the look-up table LUT of illumination vs. maximum output power (L, Pmax) built in the controller 120 is, for example, stored in a memory, and the look-up table LUT of illumination vs. maximum output power (L, Pmax) can be updated and corrected periodically. In addition, the power manager 130 is electrically connected to the controller 120, so that the power manager 130 can control the output power P of the solar cell SC. In other words, the power manager 130 has the function of determining the output power P of the solar cell SC, and the controller 120 determines the maximum output power Pmax that should be outputted by the solar cell SC according to the illumination L detected by the photo-sensor 110. For example, the controller 120 has a plurality of input/output terminals to receive the signal outputted by the photo-sensor 110, output the control signal to power manager 130, and monitor the output power P of the solar cell SC.

The embodiment uses the photo-sensor 110 accompanied with the look-up table LUT of illumination vs. maximum output power (L, Pmax) built in the controller 120 to improve the problems in conventional dynamic tracking (i.e. time consuming or difficulty in tracking the correct maximum output power). In other words, the power management system 100 of the embodiment can quickly and correctly determine the corresponding maximum output power Pmax of the solar cell SC without performing dynamic tracking.

In the embodiment, the photo-sensor 110, for example, continuously detects the illumination L of the environment the solar cell SC is located, and the controller 120 continuously updates the corresponding maximum output power Pmax according to the look-up table LUT of illumination vs. maximum output power (L, Pmax) and the illumination L detected by the photo-sensor 110. In other embodiments, the illumination L of the environment the solar cell SC is located can be periodically detected, and the controller 120 can periodically update the corresponding maximum output power Pmax according to the look-up table LUT of illumination vs. maximum output power (L, Pmax) and the illumination L detected by the photo-sensor 110.

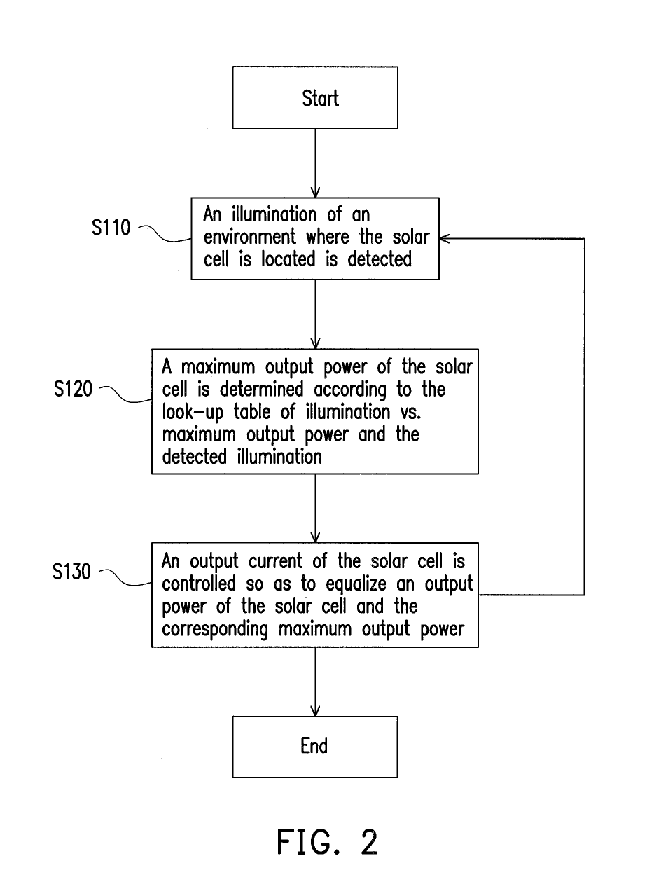

FIG. 2 is a schematic view of a flow diagram of a power management method according to an embodiment of the invention. Referring to FIG. 1 and FIG. 2, a power management method of the embodiment can be used to manage an output power P (shown in FIG. 1) of a solar cell SC (shown in FIG. 1). The power management method includes the following steps (step S110, step S120, and step S130). First, an illumination L of an environment where the solar cell SC is located is detected (step S110). Next, a maximum output power Pmax of the solar cell SC is determined according to the look-up table LUT of illumination vs. maximum output power (L, Pmax) and the detected illumination L (step S120). Then, an output current of the solar cell SC is controlled so as to equalize an output power P of the solar cell SC and the maximum output power Pmax (step S130). After step S130 is completed, if the illumination L detected by the photo-sensor 110 does not have a quick or severe change (i.e. the change in illumination is lower than a preset threshold limit value), then the output power Pmax of the solar cell SC is not adjusted temporarily. However, the illumination L detected by the photo-sensor 110 does have a quick or severe change (i.e. the change in illumination is higher than a preset threshold limit value), then the steps S110, S120, and S130 are repeated to determine the new maximum output power Pmax. It should be noted that one skilled in the art can determine the threshold limit value according to practical need and experience.

How to determine the maximum output power Pmax of the solar cell is explained in detail below.

In order to quickly and accurately calculate the maximum output power Pmax of the solar cell SC, the look-up table LUT of illumination vs. maximum output power (L, Pmax) usually needs an ample amount of candidate information sets. Each of the candidate information sets respectively includes a candidate illumination and a candidate maximum output power (the candidate maximum output power is, for example, shown in the form of a corresponding output voltage or output current). Since the interval between each candidate illumination is small enough, thus, the controller 120 will directly select a candidate illumination from the look-up table LUT of illumination vs. maximum power output (L, Pmax) closest to the illumination L detected by the photo-sensor 110, and set the candidate output power corresponding to the candidate illumination as the corresponding maximum output power Pmax.

The larger the amount of candidate information (i.e. the interval between each candidate illumination is smaller), the faster and more accurate the calculation of the corresponding maximum output power Pmax. However, the memory required to store the candidate information has to be larger. In order to effectively decrease the amount of candidate information and the space taken up in the memory by the candidate information, the controller 120 of the embodiment can select two candidate illuminations from the look-up table LUT of illumination vs. maximum power output (L, Pmax) closest to the illumination L detected by the photo-sensor 110, and then calculate the maximum output power Pmax through interpolation or extrapolation. In detail, when the illumination L detected by the photo-sensor 110 is between the two selected candidate illuminations, the maximum output power Pmax is calculated using interpolation. On the other hand, when the illumination L detected by the photo-sensor 110 is not between the two selected candidate illuminations, the maximum output power Pmax is calculated through extrapolation.

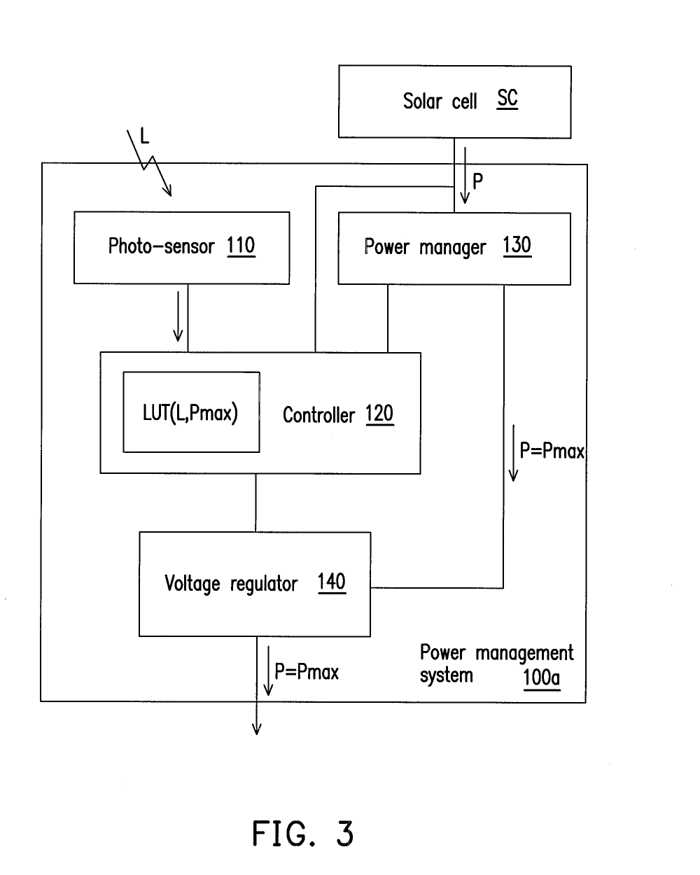

FIG. 3 is a schematic view of a power management system according to a second embodiment of the invention. Referring to FIG. 3, a power management system 100a of the embodiment is similar to the power management system 100 of the first embodiment. The difference is that the power management system 100a of the embodiment further includes a voltage regulator 140. The voltage regulator 140 is electrically connected to the power manger 130 and the controller 120.

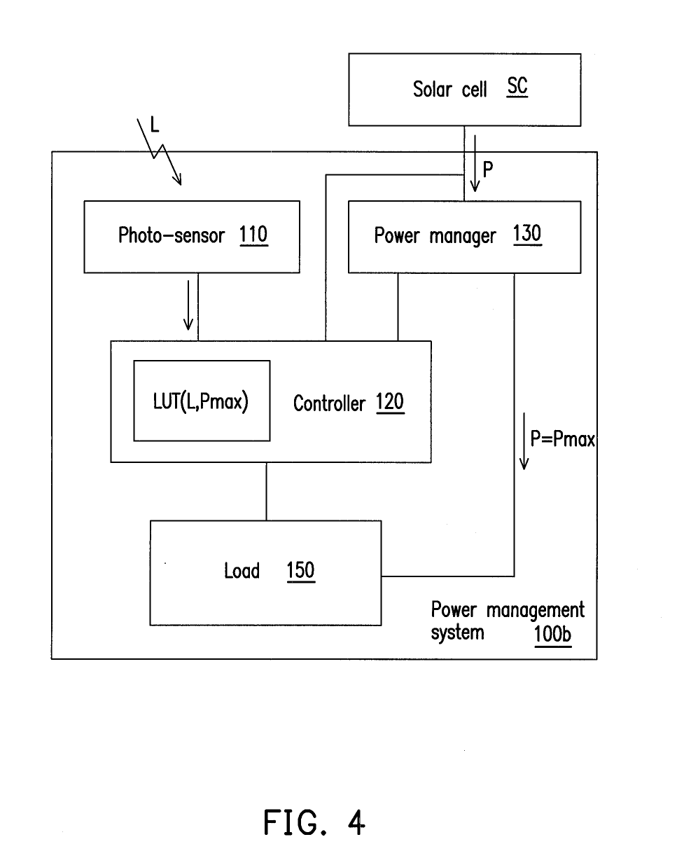

FIG. 4 is a schematic view of a power management system according to a third embodiment of the invention. Referring to FIG. 4, a power management system 100b of the embodiment is similar to the power management system 100 of the first embodiment. The difference is that the power management system 100b of the embodiment further includes a load 150. The load is, for example, selectively electrically connected to the power manger 130 and the controller 120. It should be noted that the load 150 of the embodiment is, for example, a battery, used to store the electrical energy produced by the solar cell SC. However, one skilled in the art can adopt other components to act as the load 150 according to design requirements, to adequately use the electrical energy produced by the solar cell SC.

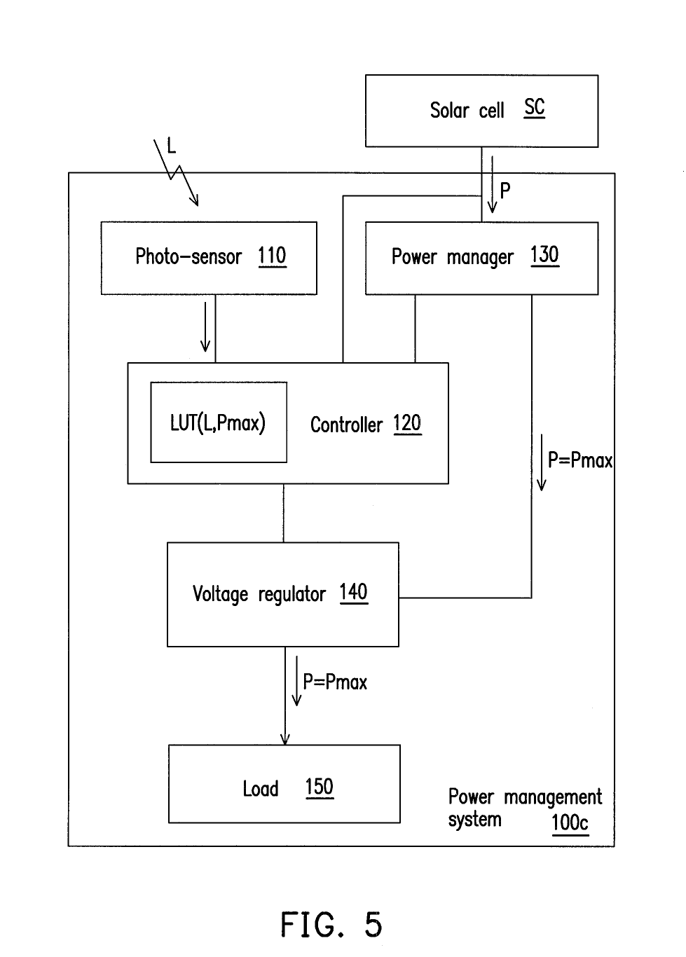

FIG. 5 is a schematic view of a power management system according to a fourth embodiment of the invention. Referring to FIG. 5, a power management system 100c of the embodiment is similar to the power management system 100 of the first embodiment. The difference is that the power management system 100c of the embodiment further includes a voltage regulator 140 and a load 150. The voltage regulator 140 is electrically connected to the power manger 130 and the controller 120, and the load 150 is electrically connected to the voltage regulator 140.

Since the invention adopts a photo-sensor to detect the illumination of an environment where a solar cell is located, and builds a look-up table of illumination vs. maximum output power in a controller, thus the power management system and the power management method of the invention can quickly and correctly obtain the maximum output power of the solar cell, causing the electrical power generated by the solar cell to be effectively used.

Although the invention has been disclosed by the above embodiments, they are not intended to limit the invention. Those skilled in the art may make some modifications and alterations without departing from the spirit and scope of the invention. Therefore, the protection range of the invention falls in the appended claims.

What is claimed is:

1. A power management system electrically connected to a solar cell, the power management system comprising:
a photo-sensor, detecting an illumination of an environment where the solar cell is located;
a controller, electrically connected to the photo-sensor, wherein a look-up table of illumination vs. maximum output power is built in the controller, and a corresponding maximum output power is determined by the controller according to the look-up table of illumination vs. maximum output power and the illumination detected by the photo-sensor; and
a power manager, electrically connected to the controller and the solar cell, wherein the power manager controls an output current and/or an output voltage of the solar cell so as to equalize an output power of the solar cell and the corresponding maximum output power.

2. The power management system as claimed in claim 1, wherein the photo-sensor continuously detects the illumination of the environment where the solar cell is located, and the controller continuously updates the corresponding maximum output power according to the look-up table of illumination vs. maximum output power and the illumination detected by the photo-sensor.

3. The power management system as claimed in claim 1, wherein the look-up table of illumination vs. maximum output power includes a plurality of candidate information sets, each of the candidate information sets includes a candidate illumination and a candidate maximum output power, and a method of the controller determining the maximum output power comprises:
selecting a candidate illumination from the look-up table of illumination vs. maximum power output closest to the illumination detected by the photo-sensor, and setting the candidate output power corresponding to the candidate illumination as the corresponding maximum output power.

4. The power management system as claimed in claim 1, wherein the look-up table of illumination vs. maximum output power includes a plurality of candidate information sets, each of the candidate information sets includes a candidate illumination and a candidate maximum output power, and a method of the controller determining the maximum output power comprises:
selecting two candidate illuminations from the look-up table of illumination vs. maximum power output closest to the illumination detected by the photo-sensor, wherein the illumination detected by the photo-sensor is between the two candidate illuminations; and
calculating the corresponding maximum output power through interpolation.

5. The power management system as claimed in claim 1, wherein the look-up table of illumination vs. maximum output power includes a plurality of candidate information sets, each of the candidate information sets includes a candidate illumination and a candidate maximum output power, and a method of the controller determining the maximum output power comprises:
selecting two candidate illuminations from the look-up table of illumination vs. maximum power output closest to the illumination detected by the photo-sensor, wherein the illumination detected by the photo-sensor is not between the two candidate illuminations; and
calculating the corresponding maximum output power through extrapolation.

6. The power management system as claimed in claim 1, further comprising a voltage regulator, electrically connected with the power manager and the controller.

7. The power management system as claimed in claim 6, further comprising a load, electrically connected with the power manager.

8. The power management system as claimed in claim 7, wherein the load comprises a battery.

9. The power management system as claimed in claim 1, further comprising a load, electrically connected with the power manager and the controller.

10. A power management method, for managing an output power of a solar cell, the power management method comprising:
detecting an illumination of an environment where the solar cell is located;
determining a corresponding maximum output power of the solar cell according to a look-up table of illumination vs. maximum output power and the detected illumination; and
controlling an output current and/or an output voltage of the solar cell so as to equalize an output power of the solar cell and the corresponding maximum output power.

11. The power management method as claimed in claim 10, wherein the illumination of the environment where the solar cell is located is continuously detected, and the corresponding maximum output power is continuously updated.

12. The power management method as claimed in claim 10, wherein the look-up table of illumination vs. maximum output power includes a plurality of candidate information sets, each of the candidate information sets includes a candidate illumination and a candidate maximum output power, and a method of the determining the corresponding maximum output power comprises:
selecting a candidate illumination from the look-up table of illumination vs. maximum power output closest to the illumination detected by the photo-sensor, and setting the candidate output power corresponding to the candidate illumination as the corresponding maximum output power.

13. The power management method as claimed in claim 10, wherein the look-up table of illumination vs. maximum output power includes a plurality of candidate information sets, each of the candidate information sets includes a candidate illumination and a candidate maximum output power, and a method of the determining the corresponding maximum output power comprises:
selecting two candidate illuminations from the look-up table of illumination vs. maximum power output closest to the illumination detected by the photo-sensor, and the illumination detected by the photo-sensor is between the two candidate illuminations; and
calculating the corresponding maximum output power through interpolation.

14. The power management method as claimed in claim 10, wherein the look-up table of illumination vs. maximum output power includes a plurality of candidate information sets, each of the candidate information sets includes a candidate illumination and a candidate maximum output power, and a method of the determining the corresponding maximum output power comprises:
selecting two candidate illuminations from the look-up table of illumination vs. maximum power output closest to the illumination detected by the photo-sensor, and the illumination detected by the photo-sensor is not between the two candidate illuminations; and
calculating the corresponding maximum output power through extrapolation.
